(19) United States
(12) Patent Application Publication
(10) Pub. No.: US 2013/0322277 A1
(43) Pub. Date: Dec. 5, 2013

(54) MEASUREMENTS AND INTERFERENCE AVOIDANCE FOR DEVICE-TO-DEVICE LINKS

(71) Applicant: INTERDIGITAL PATENT HOLDINGS, INC, Wilmington, DE (US)

(72) Inventors: Kiran K. Vanganuru, King of Prussia, PA (US); Hongsan Sheng, Chester Springs, PA (US); Gregory S. Sternberg, Mt. Laurel, NJ (US); Tao Deng, Roslyn, PA (US); Balaji Raghothaman, Chester Springs, PA (US); Ravikumar V. Pragada, Collegeville, PA (US); Zhuorong Deng, Brooklyn, NY (US); Steven Ferrante, Doylestown, PA (US); Paul Marinier, Brossard (CA); Benoit Pelletier, Montreal (CA); Diana Pani, Montreal (CA)

(21) Appl. No.: 13/906,193

(22) Filed: May 30, 2013

Related U.S. Application Data
(60) Provisional application No. 61/654,043, filed on May 31, 2012.

(51) Int. Cl. H04W 24/08

(52) U.S. Cl. CPC H04W 24/08
USPC 370/252

(57) ABSTRACT

Disclosed herein are measurement and interference avoidance for direct device-to-device (D2D) links. A method may be implemented by a wireless transmit/receive unit (WTRU). The method may include determining a sounding reference signal (SRS) to detect high interference and facilitate measurements on a link with another WTRU. The method may also include using the SRS on a direct link with another WTRU.

### CROSS-REFERENCE TO RELATED APPLICATIONS

This application claims the benefit of U.S. Provisional Patent Application No. 61/654,043, filed May 31, 2012; the contents of which are hereby incorporated by reference in their entirety.

### BACKGROUND

Direct links between Wireless Transmit/Receive Units (WTRUs), e.g., WTRU-to-WTRU links, which may be referred to as Direct Device-to-Device (D2D) radio links, may be implemented in communications networks. Example communications networks in which D2D communications may be employed may include cellular communications networks and IEEE 802.11/IEEE 802.15 networks. Current D2D implementations have challenges associated with mobile communications. For example, some D2D implementations may not maximize spatial spectral efficiency.

### SUMMARY

Systems, methods, and instrumentalities are disclosed for facilitating direct WTRU-to-WTRU link measurements to facilitate scheduling, High Interference (HI) detection and avoidance, interference management, and link adaptation. For example, a sounding reference signal may be defined on the direct WTRU-to-WTRU link to detect High Interference and facilitate measurements for scheduling and interference management. Multiple frame formats may be defined to incorporate a reference signal. High Interference detection, reporting, and resolution procedures may be defined. Methods to report measurements feedback to facilitate scheduling and interference management are also disclosed herein.

The disclosed subject matter may be applicable to the network and WTRUs operating in a cellular network, such as an LTE-based system, for example.

Also disclosed herein are measurement and interference avoidance for direct device-to-device (D2D) links. A WTRU may implement a method that may include determining a sounding reference signal (SRS) to detect high interference and may facilitate measurements on a link with another WTRU. The method may also include using the SRS on a direct link with another WTRU.

This Summary is provided to introduce a selection of concepts in a simplified form; these concepts are further disclosed below in the Detailed Description. This Summary is not intended to identify key features or essential features of the claimed subject matter, nor is it intended to be used to limit the scope of the claimed subject matter. Further, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an another example radio access network and another example core network that may be used within the communications system illustrated in FIG. 1A;

FIG. 1E is a system diagram of an another example radio access network and another example core network that may be used within the communications system illustrated in FIG. 1A;

FIG. 2 is a diagram illustrating an example relay application;

FIG. 3 is a diagram illustrating example local offload applications;

FIG. 4 is a diagram illustrating an example XL separate carrier;

FIG. 5 is a diagram illustrating an example XL shared carrier in a frequency domain or in a time domain by dedicating certain TTIs for XLs;

FIG. 6 is a diagram illustrating example high interference (HI) events provided with two transmitting WTRUs and two receiving WTRUs;

FIG. 7 is a diagram illustrating an example scenario in which an HI event occurs between a TRL and an XL, and in which the resources used for TRL and XL are shared on the same radio resources;

FIG. 8 is a diagram illustrating example subframe structures using LTE physical resource blocks (PRBs) as a reference;

FIG. 9 is a diagram illustrating example subframe structures for the XL that are backward compatible with an LTE uplink;

FIG. 10 is a diagram illustrating an example scenario in which an HI event is detected at a higher priority receiver;

FIG. 11 is a diagram illustrating an example scenario in which an HI event is detected at a lower priority receiver;

FIG. 12 is a diagram illustrating an example scenario in which two WTRU-to-WTRU links belonging to separate cells are likely to interfere with each other at a cell edge;

FIG. 13 is a diagram illustrating interference coordination of orthogonal resources in which a WTRU UE2 is configured to make power measurements over both radio resources 1 and 3; and

FIG. 14 is a diagram illustrating an example scenario in which a WTRU-to-WTRU link from cell B interferes with a TRL radio link in cell A.

### DETAILED DESCRIPTION

A detailed description of illustrative examples will now be described with reference to the various Figures. Although this description provides a detailed example of possible implementations, it should be noted that the details are intended to be exemplary and in no way limit the scope of the application.

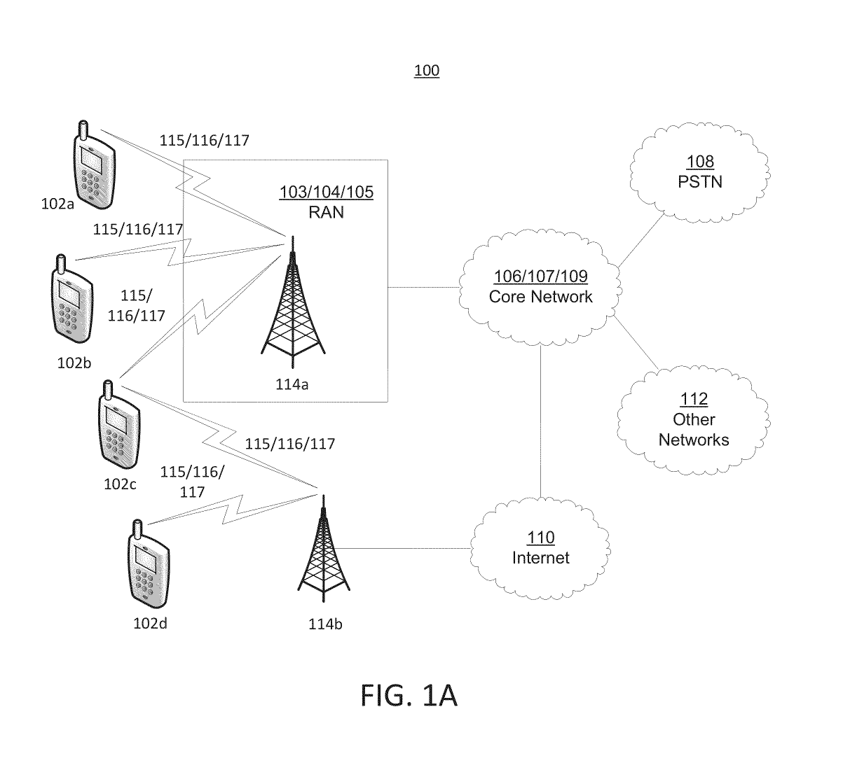

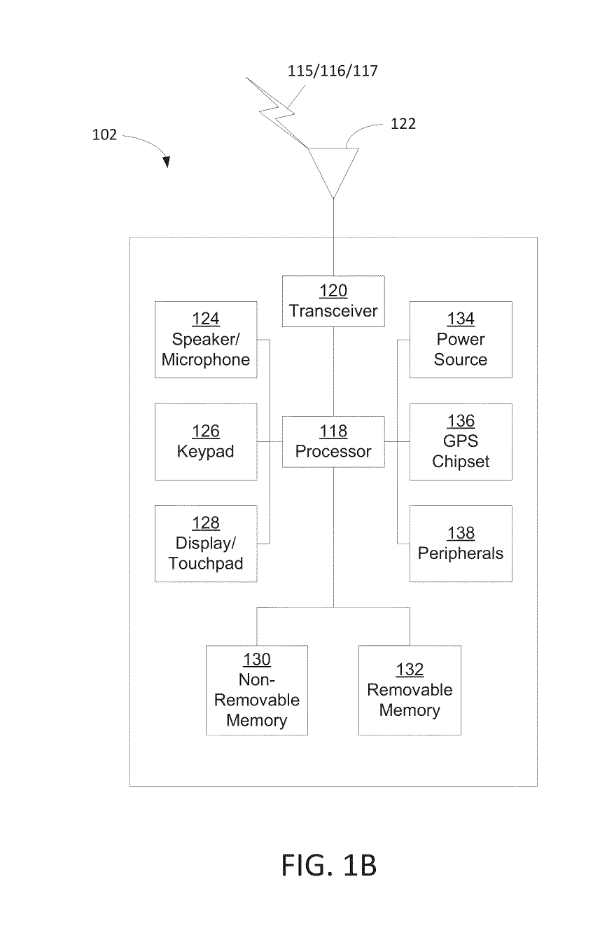

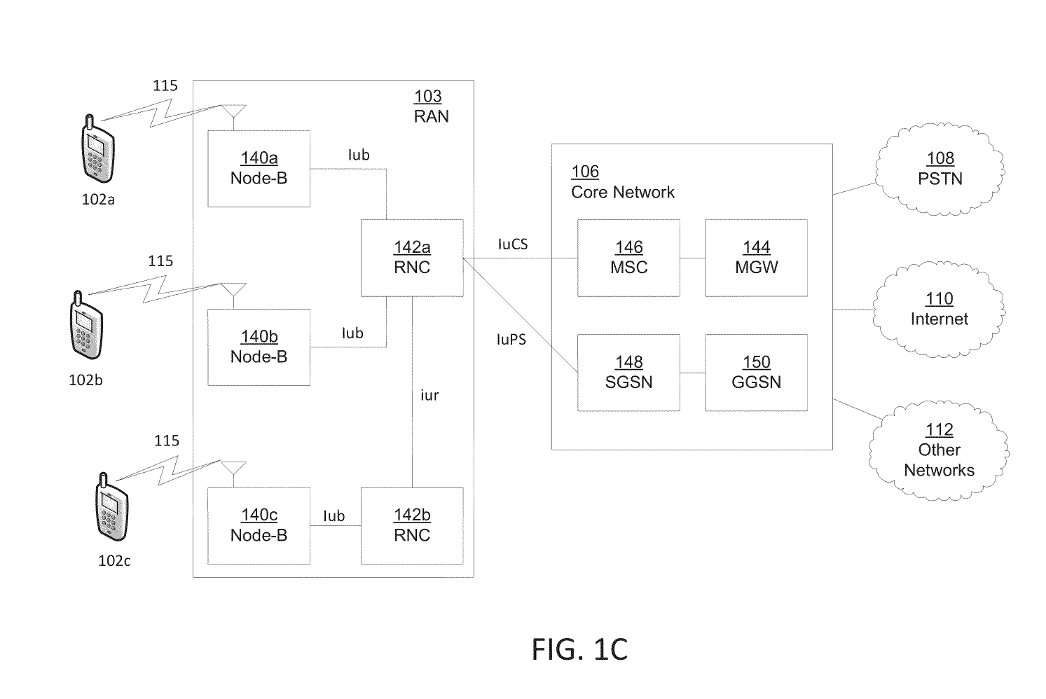

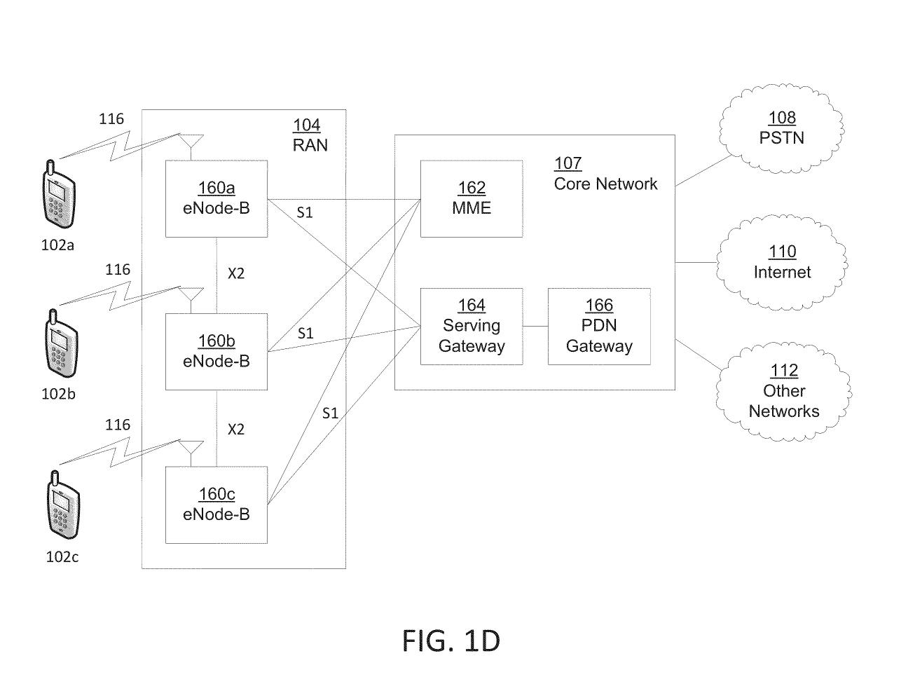

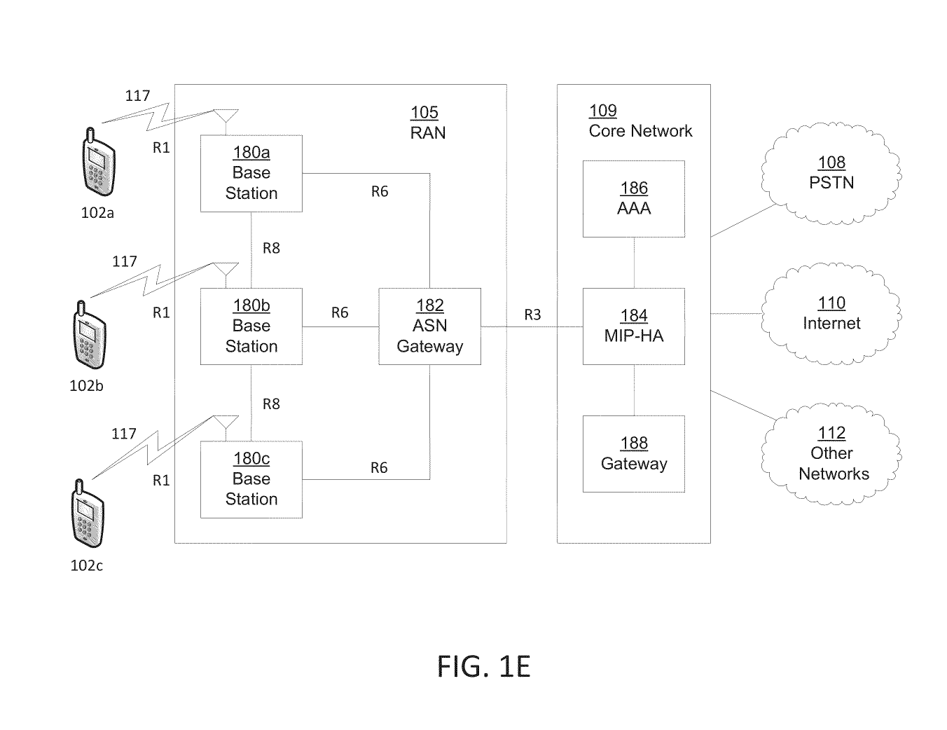

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed examples contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMD2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that may not be physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The aforementioned communication systems may be implemented in the embodiments disclosed herein. For example, a communications system may comprise direct WTRU-WTRU links, which may be referred to as Direct Device-to-Device (D2D) radio links. D2D radio links may be deployed in unlicensed bands, examples of which may include IEEE 802.11 and IEEE 802.15, for instance. These bands may use asynchronous multiple access mechanisms, such as acarrier sense multiple access with collision avoidance (CSMA/CA) protocol. Spatial coordination of two links may be done loosely using channel sensing and Request To Send/Clear To Send (RTS/CTS), which may restrict two transmitters from simultaneously transmitting if they are within the range of the channel sensing mechanism. This restriction may be enforced even if the respective receivers may successfully decode the data transmissions with high probability. The range of the carrier sensing mechanisms using RTS/CTS may be longer than the range for the data transmission, which may limit the possibility of sharing the radio resources in the spatial domain.

D2D links in 3GPP, e.g., which may be referenced under the name “Opportunity Driven Multiple Access” (ODMA), may be used as a means for efficiency of UMTS Time Division Duplex systems. 3GPP may include ways to enable direct D2D links for various proximity services. Unlike IEEE 802.11, which may use unlicensed bands, 3GPP may facilitate D2D radio links in the licensed spectrum under cellular network control. The D2D radio links under cellular domain may take advantage of centralized cellular base stations to maximize the spatial spectral efficiency through centralized interference coordination and/or scheduling mechanisms. Synchronization signals may be provided by the cellular network to enable synchronous multiple access schemes for D2D radio links.

In order to maximize spatial spectral efficiency for cellular controlled D2D links, periodic measurements may be used for interference management, scheduling, and/or link adaptation purposes. Measurements such as Reference Signal Received Power (RSRP), Received Signal Strength Indicator (RSSI), and/or Received Signal Code Power (RSCP) may be used for handoff and mobility-related procedures. In cellular networks, measurements such as RSRP and RSSI may be obtained on the reference signals or codes transmitted at regular intervals by the base stations, which may be strategically located through careful network planning In the case of D2D links, the transmitter and the receiver may be mobile. The reference signals may not be regularly transmitted, as it may be costly in terms of battery power. Therefore, measurement mechanisms may be implemented to enable or facilitate the mobility of the D2D links.

Link level feedback information such as ACK/NACK, Channel State Information (CSI), and/or MAC layer buffer status reports (BSR) may be used for fast link adaptation and/or scheduling of radio links. In cellular systems, the eNB may be responsible for fast link adaptation and/or scheduling of radio links. In cellular systems, the eNB may be responsible for fast link adaptation and/or scheduling of radio inks. For D2D links, which may provide fast link adaptation through feedback to the centralized eNB, additional delays may be incurred because of the round trip involved in eNB to WTRU radio links (TRL). To reduce or minimize the link adaptation delays, the link adaptation and scheduling functions may be split. This may allow for the link adaptation function to reside in the WTRUs participating in the D2D radio link, while the scheduling function may reside in the eNB.

Due to the mobility and dynamic scheduling of D2D links, the interference observed on each of the D2D links may be bursty. Two or more D2D links simultaneously scheduled on the same radio resources may fail to decode each of their respective transmissions due to strong mutual interference. This may lead to loss of spatial spectral efficiency. An event in which a D2D link experiences strong interference due to one or more dominant interferers may be referred to as a High Interference (HI) event. HI events may be reduced or minimized through an efficient scheduling function facilitated by measurements. In the event of an HI event, there may be mechanisms to reliably detect such events and/or report them back to the scheduling function so that they may be resolved.

D2D links using the cellular spectrum may be implemented in a wireless network, which may exploit the proximity of WTRUs to provide high data rates and/or small latencies, for example. D2D links may be facilitated in the cellular spectrum through the assistance of traditional cellular radio links (TRL) and/or the cellular network in general. The D2D links may be used for relay applications and/or local offload purposes. OFDM and/or OFDMA may be used as the modulation scheme as an example, although other multiple access schemes may be used, including, for example, SC-OFDMA. LTE and/or LTE-A standards may be described, although various standards and applications may be used to implement the examples disclosed herein. The terms D2D links and WTRU-WTRU links may be used interchangeably. To differentiate between the TRL Uplink and/or the TRL Downlink channels, the WTRU-WTRU link may be referred to as a cross link (XL). The terms D2D link, WTRU-WTRU link, and XL may be used interchangeably.

In the case of relays, a Terminal WTRU (T-WTRU) or Terminal UE (T-UE) may be able to exchange data with the network through a relay node, which may be a helper WTRU (H-WTRU) or helper UE (H-UE).

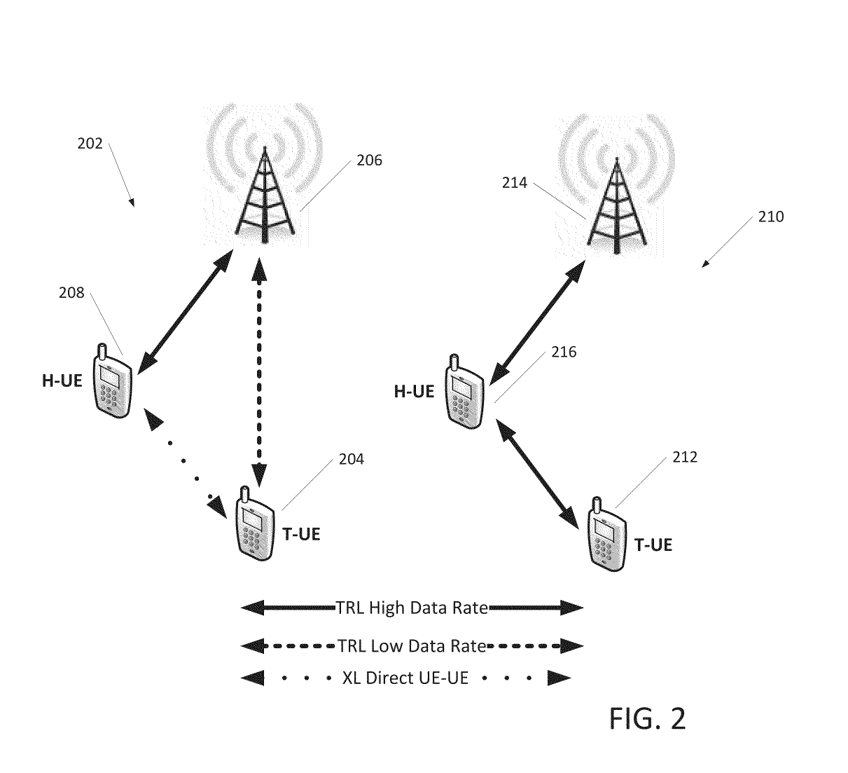

The Relay application may be in capacity mode or coverage mode as illustrated in FIG. 2, which illustrates an example relay application. In a Relay capacity mode 202, the T-WTRU 204 may communicate with the eNB 206, although with a lower data rate. An H-WTRU 208 may be assigned to the T-WTRU 204 if its throughput through the H-WTRU 208 is larger than the direct link with the eNB 206. In a Relay coverage mode 210, the T-WTRU 212 may not have a direct radio link with the eNB 214; however, its communication may be relayed through the H-WTRU 216.

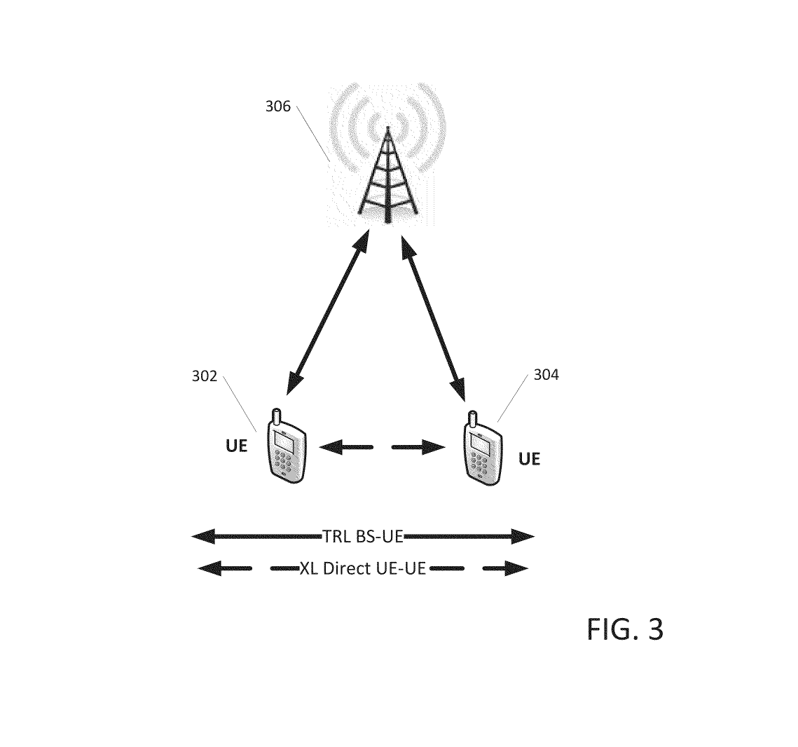

In the case of a local offload application, local traffic between two WTRUs in proximity may be directly transported over the D2D link instead of being routed through the cellular radio network, for example, as illustrated in FIG. 3, which is a diagram illustrating example local offload applications. Each WTRU 302, 304 may maintain a TRL with an eNB 306 that may be used for signaling and/or regular data applications, including access to the Internet, for example. Further, the TRL may provide synchronization signals, which may facilitate a synchronous D2D multiple access scheme.

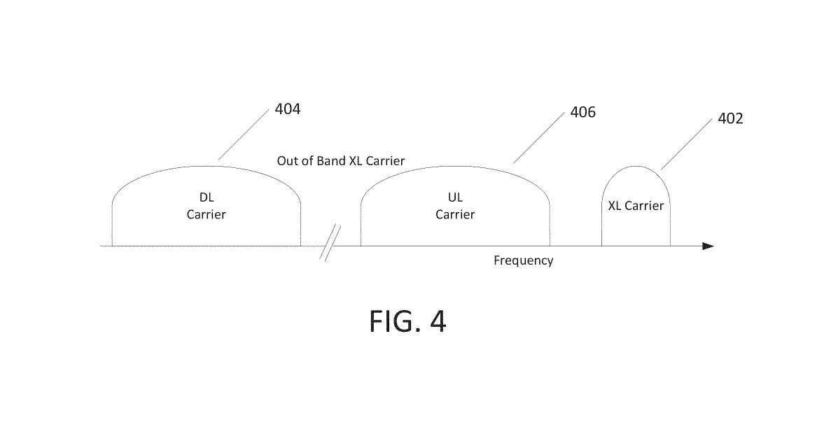

FIG. 4 illustrates an example of XL separate carriers. For example, a separate dedicated carrier may be assigned for the XLs. This approach may reduce or minimize the mutual interference between TRL and XLs, such as when there is sufficient separation between the TRL carriers and the XL carriers in the frequency domain, for example. Spectral resources may be scarce and/or expensive, and this option may be useful for large densities of D2D links with high traffic demands. An example illustration of the XL carrier is shown in the case of LTE FDD deployment in FIG. 4. The XL operating band 402 may be higher or lower than the TRL operating bands 404, 406. If the XL carrier is sufficiently separated from the TRL carrier in the frequency domain, the TRL and the XL radios may be simultaneously operated without significant self-interference in the radio front end.

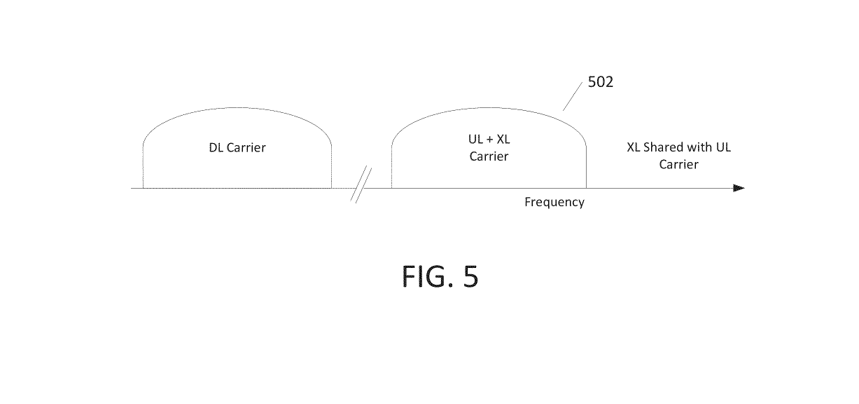

In an approach of XL shared carrier with TRL, the radio resources for the XLs may be shared with the TRL radio resources. In the case of the LTE FDD system, radio resources may be used from the uplink and the downlink carrier for XLs. The resources may be shared either in the frequency domain as shown in FIG. 5, which illustrates an example XL shared carrier 502 in the frequency domain, or in the time domain by dedicating certain TTIs for XLs, for example. Combinations of frequency and time domain sharing resources may be possible by using specific Physical Resource Blocks for XLs.

In LTE, even though resources may be used from the uplink carrier and the downlink carrier, sharing resources with the uplink carrier may have fewer complications. Sharing resources with the downlink may have more restrictiosn as legacy WTRUs may expect continuous transmission of some channels and/or reference signals like Cell Specific Reference signals, synchronization, and broadcast channels, for example. In the uplink case, since the eNB may explicitly schedule the transmissions on the uplink carrier, it may choose to not schedule TRLs on certain PRBs, which may be used for the XLs. On the downlink, resources may be assigned for the XLs on the DL carrier in the time domain, using MBSFN frame configuration and/or Almost Blank Subframe (ABS) transmissions, for example.

The specific resources to be used for XLs may be dynamically scheduled for each of the XLs separately. Alternatively, a set of radio resources may be dedicated for XLs as part of radio resource configuration. The XL link scheduling function may effectively schedule individual XLs from the resources configured for the XLs.

In an example, a duplexing mechanism may be utilized. In LTE and LTE-A, TDD and FDD options may be available for the TRL. The design of XLs may support both flavors of TRL duplexing options, while still having an independent duplexing option for the XL, for example. A TDD option for the XL may allow for time sharing the transceiver functionality between the TRL and XL. The reciprocity of the channel may be used for the XL to minimize measurement feedback in terms of the precoding matrix or channel quality indicator (CQI).

High Interference (HI) may be characterized as an event in which the receiver experiences strong interference due to one or more dominant interferers, which may result in failure to decode or detect one or more transport blocks. This may occur in a scenario in which the XL scheduling function schedules two transmissions that lead to strong interference at one or more of the receivers. The XL scheduling function may try to maximize the spatial spectral efficiency by scheduling multiple XLs on the same radio resources while trying to ensure that they are sufficiently separated in the spatial domain. However, because of WTRU mobility an the resulting long term channel variations, the scheduled transmissions may lead to excessive interference with each other, which may lead to total waste of spectral resources. When HI occurs, an HI report may be sent to the XL scheduling function to prevent future HI events.

In traditional cellular networks, such as LTE networks and/or commercial ad hoc D2D networks like IEEE 802.11 and 802.15 networks, for example, there may be provisions to provide ACK/NACK feedback to the transmitter for each transmitted block. While ACK/NACK feedback may indicate a failed reception, it may not effectively identify the cause of the failed transmission. The transmitter may interpret the failure to receive the transmission as being due to deteriorating radio conditions. Further Signal to Interference plus Noise Ratio (SINR) based measurements, such as channel quality indicator (CQI), may provide no more information to indicate the cause of the failure. If the scheduling function or the transmitters are not aware of an HI event, it may subsequently schedule retransmissions, which may result in further HI events and/or lead to further loss of spatial spectral efficiency.

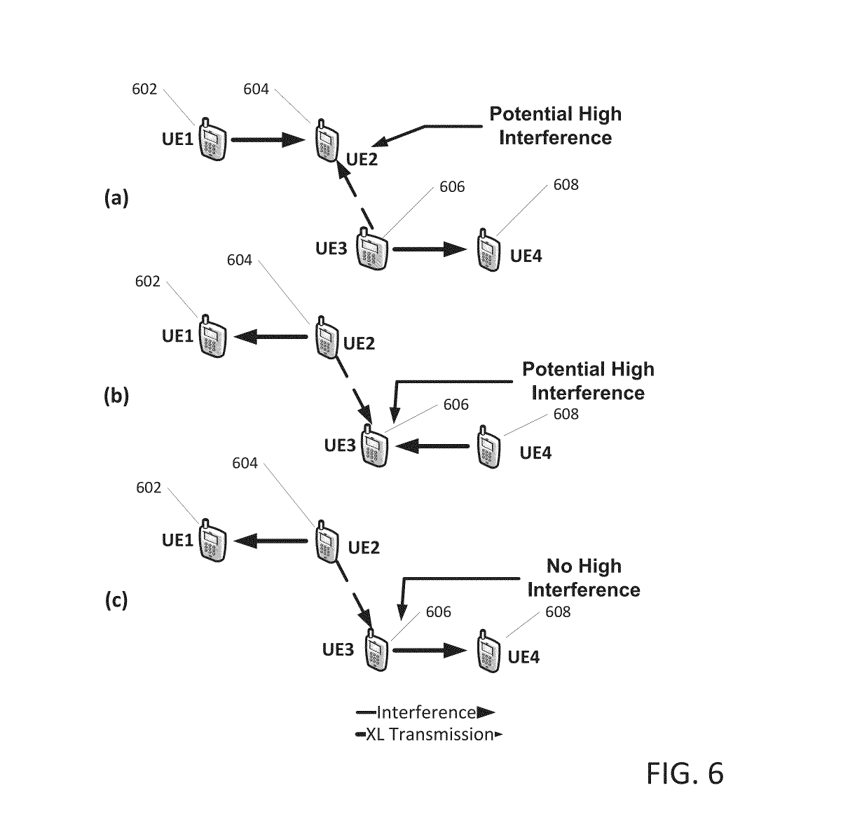

FIG. 6 illustrates an example of HI events with two transmitting WTRUs and two receiving WTRUs. As shown at (a), a WTRU 602 and a WTRU 606 are scheduled for transmission, while a WTRU 604 and a WTRU 608 are scheduled for receiving. In the presence of strong interference from WTRU 606 to WTRU 604, WTRU 604 may completely fail to receive its transmissions. To mitigate the probability of an HI event, the scheduling function may not schedule transmissions from WTRU 606 while WTRU 604 is receiving on the same radio resources.

In the example shown at (b), WTRUs 604 and 608 may be scheduled for transmission, while WTRUs 602 and 606 may be scheduled for receiving. Due to channel reciprocity, transmissions from WTRU 604 may result in HI at the receiver of WTRU 606. However, channel reciprocity may occur if the transmit powers are identical for the transmitters. Alternatively, the scheduling function, which may have global knowledge of the transmit power grants, may predict the HI event shown at (b), based on measurements obtained in the example shown at (a), for example.

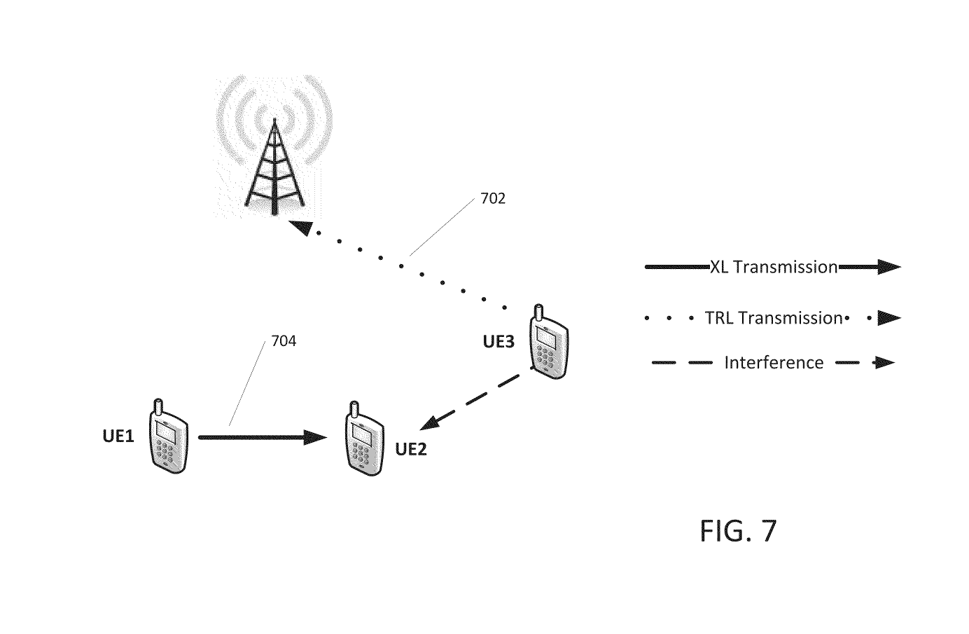

In the example shown at (c), HI may not occur because any interference from WTRU 604 to WTRU 606 occurs while WTRU 606 is transmitting. FIG. 7 illustrates an example scenario in which an HI event may occur between a TRL and XL, in which the resources used for TRL and XL may be shared on the same radio resources.

In the case of dedicated resources for WTRU-WTRU links, it may be determined which of the transmitting and receiving WTRU pairs may be simultaneously scheduled in order to maximize the spatial spectral efficiency. In the case of shared spectral resources between the eNB-WTRU and WTRU-WTRU links, it may be determined which eNB-WTRU and WTRU-WTRU links may simultaneously be scheduled to maximize the spatial spectral efficiency.

In order to facilitate such scheduling, the scheduling function may use periodic measurements. Further, if two links are scheduled such that either of the receiving WTRUs experience High Interference (HI), which may lead to transport block failures, for example, the scheduling function may be provided feedback about such events. Further, the High Interference detection mechanism may be reliable with low probability of false alarm. In the event of High Interference, mechanisms may be provided for quick resolution to reduce or minimize spatial spectral efficiency losses.

The disclosed subject matter may provide mechanisms to provide periodic measurement feedback for interference management, scheduling, and link adaptation purposes. The disclosed subject matter may facilitate reliable High Interference detection and resolution mechanisms.

Example XL subframe structures are disclosed herein for a scenario in which a set of dedicated radio resources may be used for the XLs. The dedicated resources may involve a dedicated XL carrier. In another example, a shared carrier structure may be used in which, within the TRL carrier, a set of PRBs may be assigned for the XLs. To maximize the spatial spectral efficiency, the eNB may schedule multiple simultaneous XLs on the same dedicated radio resources, as long as each of the XLs is sufficiently separated in space from the others.

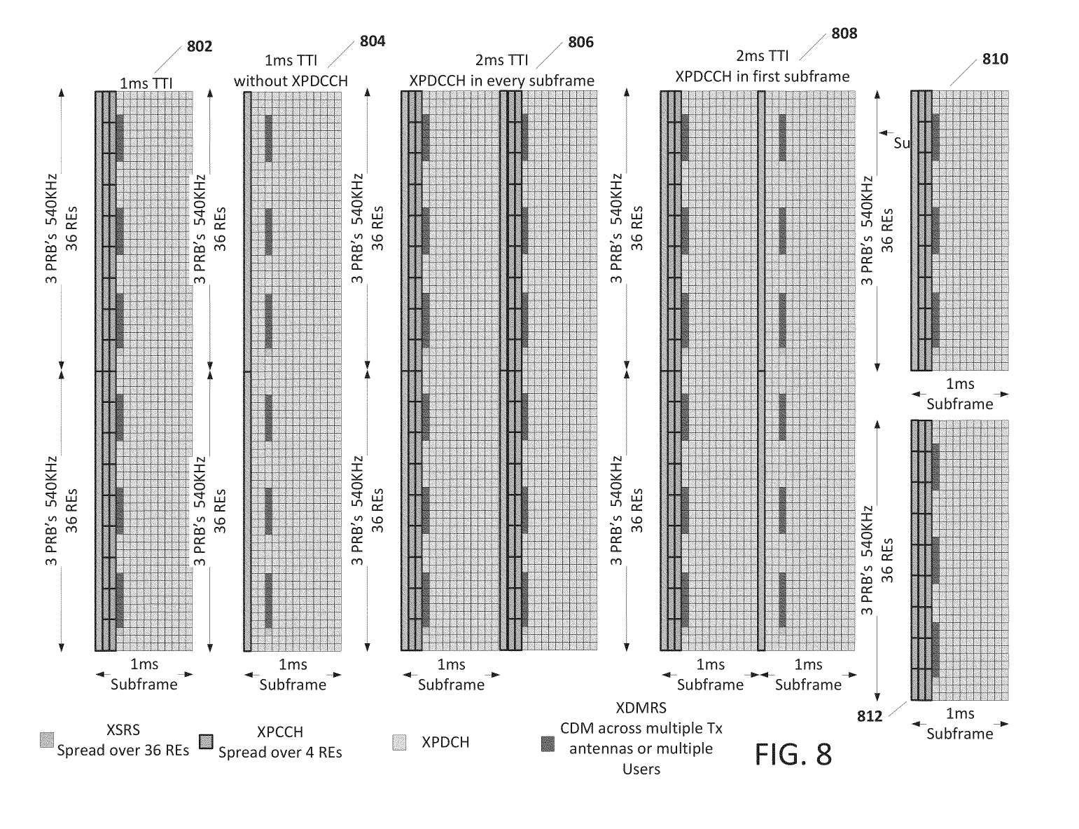

FIG. 8 illustrates example subframe structures 802, 804, 806, 808, 810, and 812 using LTE physical resource blocks (PRBs) as a reference. The subframes structures in FIG. 8 may include a number of physical layer channels and/or physical layer reference signals.

A cross link Phyiscal Control Channel (XPCCH) may be used to transmit physical layer control information similar to LTE PDCCH and/or LTE PUCCH. This channel may contain the Physical/MAC layer address of the radio link, which may be similar to the Radio Network Temporary Identifier (RNTI) in LTE, for example. The physical layer address may be defined as an ordered or unordered pair that may include the source address and the destination address. This channel may contain the scheduling assignment, such as modulation and coding scheme used for a cross link Physical Data Channel (XPDCH), for example. This channel may be used to provide fast physical layer feedback, such as Channel State Information (CSI) that may include the CQI, PMI, RI, for example. In addition, the XPCCH may be used for physical layer HARQ ACK/NACK and short measurement and HI reports to the transmitter.

A cross link Physical Data Channel (XPDCH) may be the primary data carrier and may be mapped to various transport channels supported by the MAC layer.

A cross link Sounding Reference Signal (XSRS) may be used to identify the sources of interference on the XPCCH and XPDCH. It may be used to identify the cause for failure to receive a transmission, either on the XPDCH or the XPCCH, for example, which may be due to an HI event with another interfering transmitter, or due to channel fading or excessive background noise. It may also be used for channel estimation to demodulate XPCCH.

A cross link Demodulation Reference Signal (XDMRS) may be used for channel estimation to demodulate XPDCH. This reference signal may be multiplexed in the code domain to provide channel estimates for each of the transmit antenna ports. Further, XDMRS may reflect the effect of any precoding that may be applied at the transmitter. Reference signals may be code division multiplex across multiple transmitters, which may be similar to the Orthogonal Cover Code used in LTE Uplink, for example. Multiplexing multiple WTRUs simultaneously with multiple transmit antennas may incur a large reference signal overhead with respect to radio resources.

Other physical layer reference signals and channels may facilitate features such as Neighbor Discovery.

One scenario illustrated in FIG. 8 is the example of a variable transmit time interval (TTI). In the subframe structures 802 and 804, the TTI length is equal to one subframe, while in the subframe structures 806 and 808, the TTI length is equal to 2 ms. A variable length TTI may be useful because each of the D2D links may have diverse data rates and/or latency requirements. Further, with a TDD XL, a variable length TTI may facilitate variable duplexing cycles across multiple D2D links. In the subframe structure 804, the XPCCH may not be present. This may be useful in a scenario in which an eNB may signal the transmission parameters (e.g., MCS and the like) used for the XL for each D2D link in each TTI through channels like LTE PDCCH and the feedback may be reported to the eNB on the TRL through channels like LTE PUCCH and PUSCH. The subframe structures 806 and 808 may involve a multiple subframe TTI in which the later subframe structure XPCCH may be transmitted in the first subframe to minimize overhead.

If the density of the D2D links is not high, a fixed set of resources may be assigned for XSRS and the associated measurement feedback may be high compared to a system with dynamic resource configuration. To limit this overhead, XSRS may be transmitted with a higher periodicity. Further, XSRS may be transmitted when explicitly triggered by eNB signaling, for example, with dynamic resource allocation. The subframe structures 810 and 812 may involve the scheduling of three PRBs. In the subframe structure 810, XSRS is transmitted, while in the subframe structure 812, XSRS is not transmitted. Further, in the subframe structure 812, there may be three OFDM symbols for XCCH. The length of the XCCH may be signaled through TRL, or it may be embedded in XCCH itself, such as by including a length indicator field in XCCH, which may be demodulated independently.

The spreading factors of various physical channels and reference signals along with their positions in the TTI in FIG. 8 are shown by way of illustration and not limitation. Other realizations are also possible and may also lend themselves to the examples disclosed herein.

In a mode employing spatially shared XL resources with TRL, both the TRL and the XL may share the same, or similar, radio resources, as shown in FIG. 7. This may be done as long as the TRL and the XL do not cause mutual interference to each other. Because the TRL may be transmitted at a larger power (large range) compared to a D2D link, a few D2D links may simultaneously share the resources with the TRL in the spatial domain while still being spatially spectrally efficient. LTE Uplink may be used as the baseline to share the resources between the TRL and XL. There are various ways to detect an HI event and/or take measurements. For example, one way may use LTE Uplink DMRS, while another may use LTE Uplink aperiodic SRS.

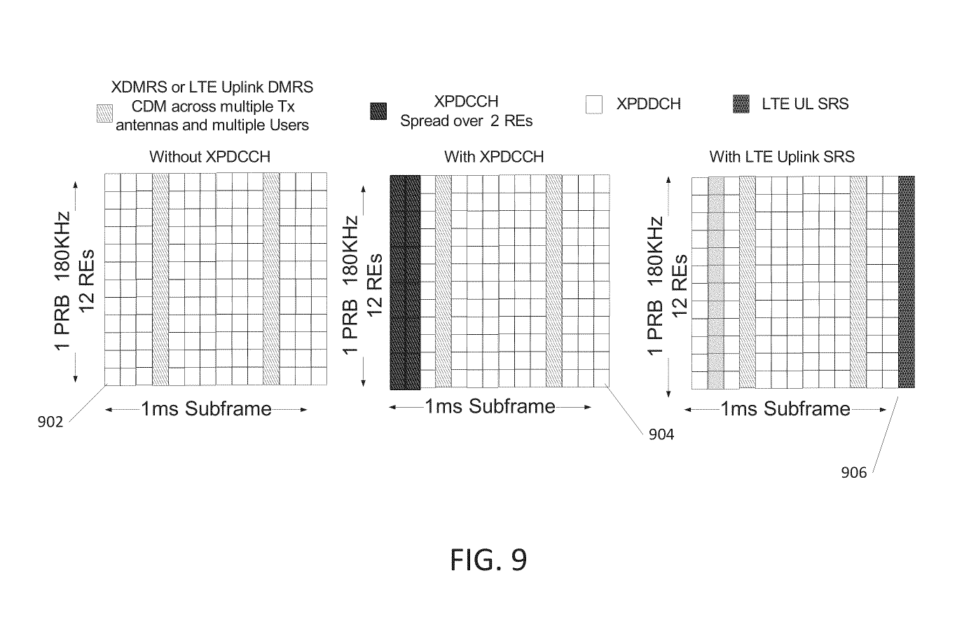

FIG. 9 illustrates various examples of subframe structures 902, 904, 906 for the XL that may be compatible with LTE Uplink. XDMRS may use the same structure as the LTE Uplink DMRS and may be transmitted to remain backward compatible with LTE. As shown in FIG. 9, the XDMRS may occupy the fourth OFDM symbol of each slot containing seven OFDM symbols. XDMRS may be multiplexed (e.g., CDM) across multiple transmit antennas. Similarly to LTE Uplink, an orthogonal cover code (OCC) may be used to separate XDMRS and LTE Uplink DMRS transmissions from multiple users. An eNB or WTRU receiver may detect a High Interference event by correlating XDMRS against the set of known DMRS codes scheduled by the eNB. RSCP measurements may be reported for each of the codes so that the eNB may schedule the XL and TRL transmissions with minimal mutual interference, for example. This approach may not scale well for large numbers of simultaneous D2D transmissions because it may take up a large number of resources simultaneously multiplexing (e.g., CDM) both the number of WTRUs and the number of transmit antennas.

In the subframe structure 906, an aperiodic SRS (A-SRS) may be transmitted on the last symbol of the subframe. This approach may be backward compatible with LTE Uplink, which may have the ability to dynamically schedule A-SRS transmissions. The A-SRS transmissions may be configured to be sent through a single antenna port, which may use fewer resources to identify a given number of transmitting WTRUs. An eNB or WTRU receiver may identify an HI event, such as by correlating the received signal with the set of possible A-SRS codes, for example. The eNB may explicitly signal to the WTRU the specific set of A-SRS codes to be used for measurements and HI detection. The WTRU receiver may make RSCP measurements on the configured set of A-SRS codes, which may be reported to the eNB for scheduling and interference management purposes.

In the subframe structures 902 and 906, XPCCH may not be transmitted on the D2D link. These subframe structures may be suitable for the scenario in which the eNB may be responsible for dynamic scheduling and link adaptation on a TTI basis, in which case the physical layer feedback may include ACK/NACK, CQI, Channel State Information (CSI), and/or High Interference Indicator (HII). This measurement feedback may be reported on the TRL, like LTE PUCCH and PUSCH, for example. In the subframe structure 904, XPCCH may be transmitted along with XPDCH. This format may be suitable for scenarios in which the WTRU may be responsible for link adaptation and the eNB may be responsible for scheduling and interference management.

In an example, a cross link sounding reference signal (XSRS) may be utilized. In this example, XSRS may be spread across a given number of Resource Elements (REs) over a given minimum bandwidth of transmission. This minimum bandwidth may be referred to as a subband. The code to be used for transmission on the XSRS may be signaled as part of the transmission grant to the WTRU. The set of possible codes that may be transmitted on the XSRS may be derived from an orthogonal family of codes similar to Zadoff-Chu (ZC) Sequences.

The total number of possible codes on the XSRS may be increased by using non-orthogonal codes. Orthogonal codes may allow for more accurate measurements and/or identification of HI events. Orthogonal codes may have a larger number of time frequency resources for a given number of codes.

Each of the transmitting WTRUs during a TTI may be granted a code to be used on the XSRS. The code to be used may be signaled as part of the scheduling grant.

Multiple WTRUs within radio propagation distance may be scheduled for transmission with the same XSRS code. This probability may be reduced or minimized by the XL scheduling function for point to point links because the receiving nodes may not have the ability to identify the different transmitting WTRUs by using the XSRS alone and may rely on other channels.

If the transmitting WTRU is scheduled for multiple subbands, the XSRS in each subband may use the same code. This may allow for uniquely identifying the transmitter across the frequency bands. In another example, the codes used in each of the XSRSs across multiple subbands and TTIs for a single transmitter may be based on a code hopping sequence.

When multiple transmit antennas are employed, each antenna may have a separate XSRS code. This may limit the number of unique transmitters that may be identified by the receiving WTRUs for a given set of XSRS codes.

With multiple transmit antennas, a single XSRS code may be used for each transmitting WTRU through transmit beam forming, which may create a single transmit antenna port.

XSRS may be used as a reference channel to obtain channel estimates for the signal of interest, which may in turn be used to demodulate the XPCCH. In order for this to occur, the number of logical transmit antenna ports may be identical for both XSRS and XPCCH channels.

The XSRS code space may be separated into multiple groups, which may be used for interference management purposes, such as by ensuring that two WTRUs using the same XSRS code may be separated in space as much as possible.

To provide higher reliability to the XPCCH channel, the spreading code used for XPCCH may be derived from the XSRS Code. This may mean splitting the XSRS code space into multiple disjoint code groups, and may be further used as an interference management tool to further avoid transport block errors on XPCCH and XPDCH, for example.

Referring again to FIG. 8, an example configuration is illustrated of the XSRS while using LTE subcarrier spacing as a baseline. As illustrated, XSRS may span 36 Resource Elements (REs) and may occupy the first symbol of transmission in each subframe across a subband spanning three Physical Resource Blocks (PRBs). With this configuration, 36 unique and orthogonal XSRS codes may be implemented. This may allow for a receiving WTRU to uniquely identify each transmitting WTRU with high probability. The number of Resource Elements and the symbol location for XSRS depicted in FIG. 8 are for illustration purposes only, as alternate realizations may also be derived.

In an example, WTRU receiver XSRS processing may be utilized. In this example, each WTRU receiver may be scheduled to monitor a set of XSRS codes over which it may be expected to make RSCP measurements. A WTRU may be signaled to make RSCP measurements for the whole set of XSRS codes. This approach may be implemented when the set of XSRS codes is small.

XSRS code space may be derived such that it may allow for efficient correlation processing at the receiver. One example of such codes may include the Zadoff-Chu (ZC) family of codes, which may allow for FFT-like structures to efficiently correlate across multiple codes simultaneously.

By correlating with each of the possible interfering XSRS codes, each WTRU receiver may identify the strongest source or sources of interference on the XPCCH and XPDCH. It may also make a good estimate of the SINR of the corresponding XPCCH and XPDCH. To improve the accuracy of the SINR estimate, each WTRU receiver may further take into account the transmit power ratios and spreading factor differences between XSRS, XPCCH, and XPDCH channels. This mechanism may apply to a subframe format in which XSRS may be transmitted by each transmitter along with the respective XPCCH and XPDCH.

In event of failure to receive an XPCCH or XPDCH transmission at the WTRU receiver, the WTRU receiver may determine the cause of the failed transmission. The failed transmission may be the result of, for example, an HI event with a strong interferer and/or due to fading or large background noise.

In an example, High Interference (HI) event detection and resolution may be implemented. The parameters that may define an HI event may be set for each WTRU receiver as part of measurement configuration through RRC signaling or it may be signaled as part of the scheduling grants. An HI event may be defined and/or configured to fail to demodulate an XPDCH transport block, while the ratio of RSCP of any interfering XSRS code to the RSCP of the desired XSRS code may be greater than a configured value.

In another example, the HI event may be defined such that the SINR of the desired signal may be below a configured threshold, while the ratio of the dominant interferer's RSCP to the rest of the interference power may be greater than a threshold.

In another example, the HI event may be defined such that the SINR of the desired signal may be below a configured threshold, while the interference may include one or two interfering sources. In another example, the HI event may be defined for failure to demodulate an XPDCH transport block for a given number of TTIs, while the interference may include one or two interfering sources.

An HI event may be defined as an event when M TTIs may lead to errors out of N consecutive TTIs, while the interference may include one or two interference sources.

In another example, the HI event may be defined such that the observed SINR may be below a configured value for M out of N TTIs. This may be because of dominant interference from the same XSRS code in each of the M TTIs, for example.

An HI event may be an indication that two or more links are scheduled on the same radio resources, while the link experiencing High Interference may have low spectral efficiency because of strong interference. The spectral efficiency of one or more links experiencing High Interference may not be improved through link adaptation. According to another example, the HI event may be resolved such that the links experiencing HI events may be scheduled on orthogonal resources, either in frequency or time domain, for example. With multiple transmitter and receiver antennas, mutual interference may be reduced by using MIMO precoding and/or Beamforming techniques to avoid the strongest interferers. It may use a mechanism to estimate the Channel State Information (CSI) for the transmitter of interest and/or the strongest interferers.

An HI event report may include any or all of the following information: interfering XSRS codes, indices of subframes during which dominant interference is observed, RSCP of the interfering codes, and/or observed SINR and RSSI.

In an example of High Interference event resolution through TRL, the eNB may be the entity where the scheduling function resides and may be responsible to resolve HI events. An HI event report may be sent by the WTRU receiver that experienced an HI event to the eNB using LTE Uplink resources.

If the WTRU has resources allocated for the uplink data channel, then the whole HI event report may be sent as a MAC Control element on the uplink data channel similar to LTE PUSCH.

If the WTRU does not have uplink data channel resources, a High Interference Indication (HII) may be sent, for example, as a one bit message on the uplink control channel, which may be similar to LTE PUCCH, for example. The WTRU may have some resources allocated on the uplink control channel, for example, if the eNB is providing scheduling grants on a TTI basis and may use feedback in terms of ACK/NACK or CSI feedback at regular intervals.

The scheduling grants for reports on the uplink channel may be provided in a semi-persistent manner at regular intervals. This may mean that the minimum latency involved n resolving an HI event may be determined by the periodicity of the semi-persistent schedule.

In another example, a set of LTE Uplink resources may be reserved in a semi-persistent manner for a set of WTRUs to send HI reports. This may be similar to a random access channel configured for a set of WTRUs and may be used to report irregular events, such as HI events. The load of HI event report feedback may be spread by grouping the WTRUs into multiple sets while assigning separate uplink resources for each group.

When an HII is received, the eNB may revoke earlier grants assigned to the corresponding WTRU transmitter. If the eNB is dynamically scheduling each D2D link every TTI, then the eNB may choose not to schedule the corresponding transmitter until the whole HI report is received by the WTRU receiver experiencing HI, for example.

When the scheduling function in the eNB receives the whole HI report, the scheduling function may resolve the HI event by scheduling the colliding links on orthogonal radio resources.

In an example of High Interference event resolution through XL, an HI event may be resolved through the assignment of a priority to each of the possible XSRS codes. In the event that two links are colliding with each other, the link with a lower priority XSRS code may stop transmitting. Since the HI event may be detected at the receiver, the interfering transmitter with the lower priority may be notified of HI.

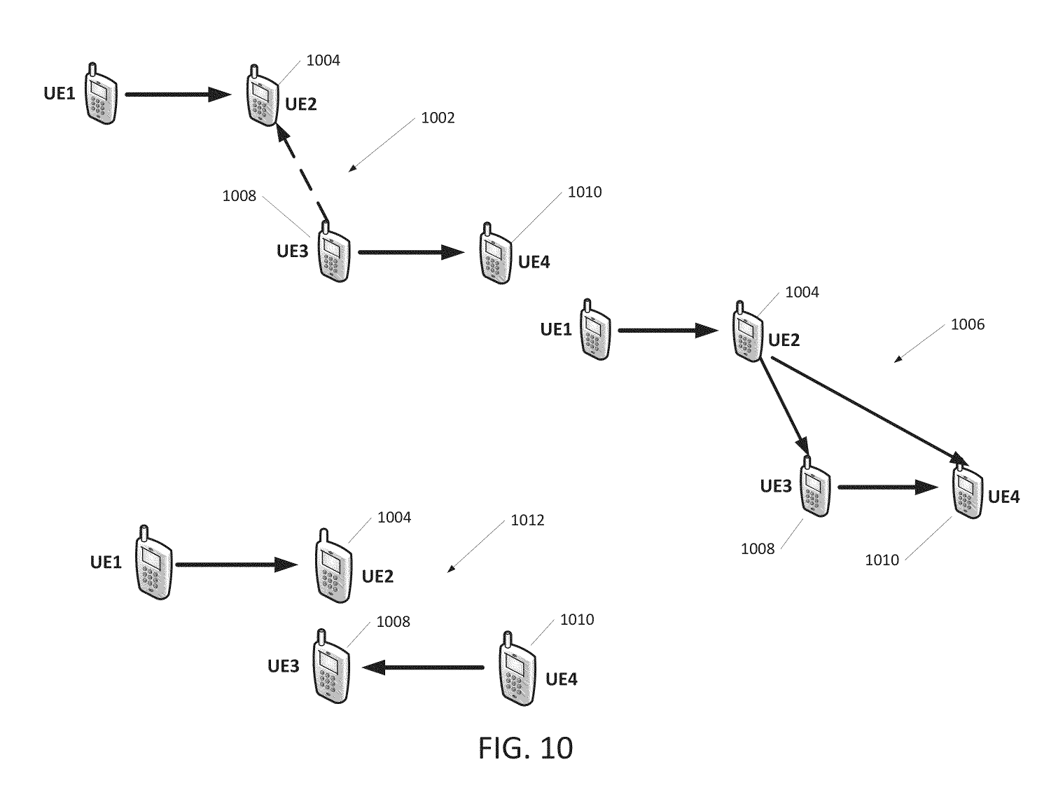

FIG. 10 illustrates an example scenario in which an HI event may be detected at the higher priority receiver. At 1002, an HI event may be detected at a WTRU 1004, which may be a higher priority link. At 1006, the WTRU 1004 may stop receiving its normal transmission, e.g., may stop listening to the normal transmission, and may broadcast a collision indicator, such as an HII. There may be no explicit scheduling grant for the transmission of the HII, and the HII may be broadcasted because the WTRU 1004 may not be aware of when the interfering transmitter, e.g., a WTRU 1008 in this example, may be in receive mode again. It may make use of the fact that the interfering transmitter or the corresponding receiver may be receiving and hopes that it may be received by one of the WTRUs. In the example shown, a WTRU 1010 may try to decode both the regular transmission from the WTRU 1008 as well as the HII. At 1012, the WTRU 1010 may forward the HII to the WTRU 1008, such as during a TTI when the WTRU 1008 is supposed to be receiving, e.g., expected to be in a receive mode, for example. The WTRU 1004 may resume its normal transmission or reception and may subsequently report the HI event to the eNB when TRL radio resources are available.

Either the WTRU 1008 or the WTRU 1010 may request a radio resource assignment from the eNB. The timing of the various events may be dependent on the scale of the scheduling grant in the time domain. This method may be useful when HI event resolution through the TRL alone has a large latency. Quick resolution of the HI event may allow at least the higher priority link to use the radio resources until the HI event is resolved.

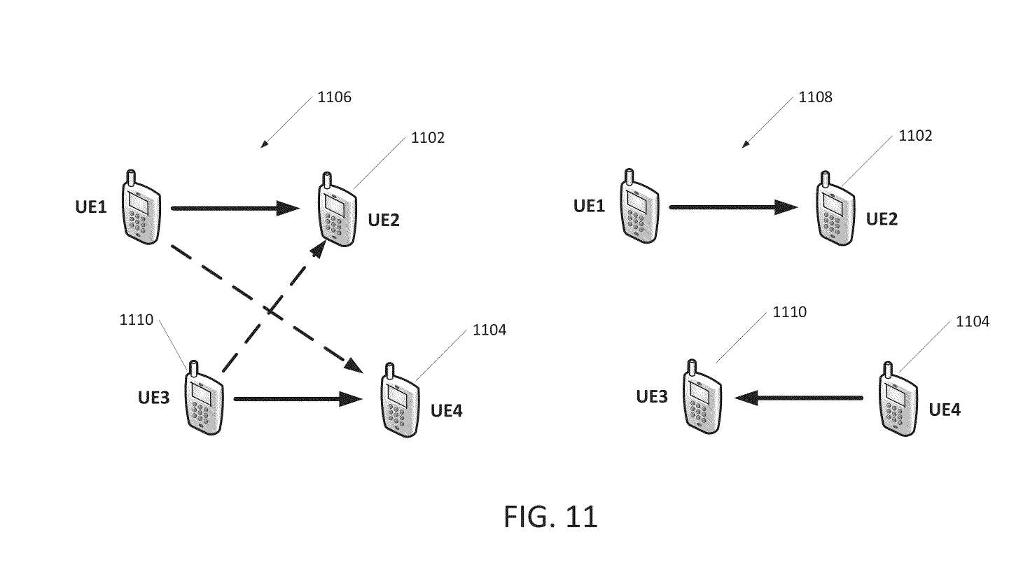

FIG. 11 illustrates an example scenario in which an HI event is detected at a lower priority receiver. As shown in FIG. 11, a WTRU 1102 may be a higher priority receiver and a WTRU 1104 may a lower priority receiver. Even though an HI event may be detected at WTRU 1102 at 1106, it may not transmit any HII on the XL. It may report the HI event to the eNB as soon as the corresponding TRL Resources are available at 1108. The lower priority receiver, e.g., WTRU 1104 in this case, may report an HII on the XL to a WTRU 1110 when it knows that WTRU 1110 may be in receive mode. WTRU 1110 and/or WTRU 1104 may report the HI event to the eNB to receive scheduling grants and/or may request for resource allocation for the eNB.

In an example of transmission of High Interference Indicator (HII) on XL, a single-bit HII may be sent on XSRS, such as by broadcasting a specific complementary code that may have a one-to-one correspondence with the XSRS code detected as part of the HI event detection, for example. This may mean that each WTRU receiver may look for the XSRS code used for its reception and its complementary code. However, since XSRS codes may be assigned to each transmitter as a pair, the number of transmitters that may be detected may be reduced by half Accordingly, the XSRS code space may be increased by adding additional non-orthogonal codes. The non-orthogonal codes may be restricted to be used for HII transmissions. With careful scheduling and interference management, the number of HI transmissions may be reduced or minimized.

Another example may involve broadcasting the HII as an explicit message on resources used for XPCCH/XPDCH. In this approach, each receiving WTRU may detect its regular transmissions and/or may detect broadcast transmissions from one or more strong interferers.

The physical layer identity or signature to be used to identify each transmitting WTRU may be defined through a combination of one or more of a number of parameters, including, for example, XSRS code or TRL Uplink SRS code; and/or frequency and time resources, including LTE Uplink SRS Comb pattern, for example.

Similar to LTE Uplink SRS Code, the XSRS code space may be separated into multiple groups such that the codes within any group may be orthogonal to each other. Further, the code may be chosen such that the cross correlation metric of any two codes from different groups may be as small as possible.

To conserve radio resources and/or reduce or minimize the processing requirements at each WTRU, the number of XSRS codes available may be less than the number of WTRUs within any given cell. Therefore, unique SRS codes may not be assigned to each WTRU. The scheduling function in the eNB may try to assign a separate XSRS code to each WTRU for the duration of its session. However, with a large number of active sessions, unique assignment may not be performed and hence the scheduling function may actively manage the XSRS code space. If the priority of radio links is implicitly embedded in the XSRS code assigned, then rotation of priority may lead to variable XSRS code assignment for a given WTRU within the duration of the session.

To improve the accuracy of the measurement and/or to reduce feedback overhead, each of the measurements may be averaged over tens or hundreds of milliseconds. The measurement interval for dynamic scheduling purposes may be configured such that the physical layer identity stays constant during the measurement period. Some of the ways this may be achieved may include assigning a constant, but not necessarily unique, XSRS code to any given WTRU transmitter. In another example, the same time frequency resources may be assigned to a given WTRU transmitter whenever it is scheduled.

Measurements including RSCP on XSRS may be configured to not include any averaging. Since the eNB may have global knowledge of the schedule, it may map the RSCP measurements corresponding to each subframe to the respective WTRUs.

Measurements that are averaged over a long period of time may be used to gather aggregate metrics. In an example, a mean interference power from neighboring cells' WTRU-WTRU links may be estimated by averaging RSCP measurements over neighboring cells' XSRS codes.

In an example of measurements configuration and reporting, each receiving WTRU may be configured to take measurements on a set of XSRS or LTE Uplink SRS codes. Further, each WTRU may be configured to take measurements on all or some of the possible XSRS codes. The measurement configuration for each WTRU may be preconfigured using RRC signaling or may be dynamically signaled. Periodic XSRS or LTE Uplink SRS measurement may involve scheduling WTRUs to measure the SRS at a regular interval.

In another example, aperiodic XSRS or LTE Uplink SRS measurement (One-Shot Measurement) may be implemented. In this example, preconfigured parameters with RRC messages and triggered with signaling on the DPCCH may be implemented. Parameters may also be dynamically signaled.

In the case of using LTE Uplink SRS as the physical layer identity, the eNB may signal the SRS configuration parameters to the WTRUs configured for measurements. Some of the example parameters for SRS configuration may include, for example, bandwidth and the number of transmit antenna ports, transmission comb parameter, cyclic shift of the SRS code, frequency hopping pattern, and/or subframe indices over which the SRS may be transmitted.

The eNB may configure one or more WTRUs to monitor the XSRS codes and report the respective received signal code power (RSCP) measurements during the measurement period. This process may be useful when the scheduling function is trying to assign resources to a D2D link and the measurements may be used to avoid potential HI events.

An example measurement type may include a received signal code power (RSCP) measurement. RSCP-based measurements may be used to identify the strongest interferers. The RSCP for each code may be defined as:

$$R S C {P}_{k} = {\vert {\sum }_{i} r ( i ) {c}_{k}^{*} ( i ) \vert}^{2}$$

where RSCPₖ may be the RSCP values for each code index requested, r(i) may be the received code of length i, and/or cₖ(i) may be the k^{th} code sequence of length i. Based on the code structure, these measurements may be optimized in implementation.

To further classify the RSCP values as interfering or not, a threshold may be applied. The threshold may be based on a correlation of the intended received code of the WTRU, e.g., Threshold=ThresholdFactorConfig*RSCP_{kown}. A High Interference event bit map HIₖ may be defined as HIₖ=(RSCPₖ>Threshold). HIₖ may be a bit map indicating the codes that passed the threshold test, e.g., high interferers.

Path loss measurements may be obtained using measurements over XSRS and/or LTE Uplink SRS, such as when the transmitted power is signaled to the receiving WTRU making measurements, for example.

The explicit transmit power to be used for measurements may be signaled as part of the scheduling grant. The receiving WTRU and the transmitting WTRU may be signaled to indicate the transmit power used for measurements.

Other forms of path loss measurements at the eNB may be employed if the WTRUs report all or some of the raw measurements, including RSCP and total power measurements, for example.

Each WTRU may be configured for fixed transmit power as part of the measurement configuration.

Other forms of SINR-like measurements may be defined, including, for example, the ratio of the RSCP of the desired signal over the total received power.

Various other power ratios may be defined, including the ratio of RSCP of the desired signal divided by the sum of RSCP over one or more dominant interferers.

Disclosed herein are some of the ways in which measurement reporting may be configured by the eNB. These measurements may be used by the scheduling function in the eNB to facilitate scheduling, link adaptation, and/or interference management. The averaging and/or filtering parameters for each of the measurements may be indicated as part of the measurement configuration. Examples may include, but are not limited to: average SNR measurement over the measurement interval, average RSCP of the desired signal and average RSSI measurements, RSCP measurements for the top N interfering XSRS codes. The measuring WTRU may send a simple one-bit flag on the PUCCH that may indicate that at least one of the measured WTRUs passed the threshold. The flag may also be extended to a multi-bit flag that may indicate the index of the top interferer and/or that there was an interferer. If there was one measured WTRU, a multi-bit flag may inform the eNB which WTRU is interfering so that the eNB may make an informed decision as to how to manage the situation.

The measuring WTRU may send a list of indices for the top N interferers along with the subframe and PRB index over which interferers were observed. In an example, it may be a bit flag having values of 1 in locations of high interferers. Based on the size of this message, the list of indices may be sent on the PUSCH. The measuring WTRU may send a scheduling request (SR). This message may be triggered by the eNB, such as after the eNB receives the initial one-bit flag indicating that there is at least one interferer present, for example.

The measuring WTRU may send the actual RSCP values for the top N interferers. Based on the size of the message, the message may be sent on the PUSCH. This may be done in periodic SRS mode and the eNB may average the RSCP values prior to making a scheduling decision change.

If the XSRS codes are classified into various groups, then the RSCP measurements belonging to the same group may be averaged to reduce or minimize the measurement feedback rate. This kind of measurement may be used if the scheduling function performs fairly at assigning XSRS modes in a group of WTRUs that may be spatially close to each other. The configuration of the XSRS groups may be signaled as part of the measurement configuration.

Received Power Measurements may be observed over a configured set of radio resources in time and frequency domains.

Measurement reporting intervals may be periodic, which may be periodic as part of the measurement configuration, for example. As another example, aperiodic measurement reporting may be defined through a predefined set of measurement events. The parameter configuration for each measurement event may be configured through prior signaling. In addition, aperiodic measurement reporting may be dynamically signaled by the base station.

Some of the events that may trigger measurement reporting may include, for example, detection of a High Interference event; detection of a weak link, leading to low link metrics including low throughput or low SINR; and/or detection of a radio link failure.

Measurement procedures may be triggered by any of a number of events, which may facilitate scheduling of resource grants and/or reduce or minimize interference to existing links. These events may include, for example, a D2D connection setup; discontinuous reception (DRX) cycle (e.g., waking up from either short or long DRX cycles); link activity management (e.g., a D2D link may resume high data rate communications after a period of low data rate communications, which may use additional radio resources); and/or handoff events (e.g., the base station may configure measurements to facilitate handoff procedures).

Coordinated measurements may be useful when a transmitter/receiver pair becomes active and the eNB may schedule resources, such that the existing links do not suffer from excessive interference, for example. It may also be used for a quick resolution for many HI event reports. Coordinated measurements may be obtained periodically to determine which links may coexist together in the spatial domain while maximizing the spatial spectral efficiency.

Coordinated measurements may be obtained by scheduling a set of WTRU transmitters with a unique XSRS code for each transmitter while scheduling a set of WTRU receivers to make RSCP measurements on each of the XSRS codes, for example. This process may be repeated over multiple TTIs while changing the set of transmitters and receiving codes. Each of the WTRUs participating in coordinated measurements may be configured to report the strongest N XSRS codes detected during each TTI, along with their RSSI measurements. The eNB may use these measurements to infer potential HI events and/or avoid scheduling them on the same radio resources.

Coordinated measurements may be done in parallel with existing transmissions. In another example, a dedicated set of resources may be periodically assigned for measurements. As an example, the last symbol of a subframe may be dedicated for XSRS transmissions for one out of every N subframes. The specific set of WTRUs transmitting and the set of receiving WTRUs making measurements during each coordinated measurement period may be dynamically scheduled or preconfigured through RRC signaling.

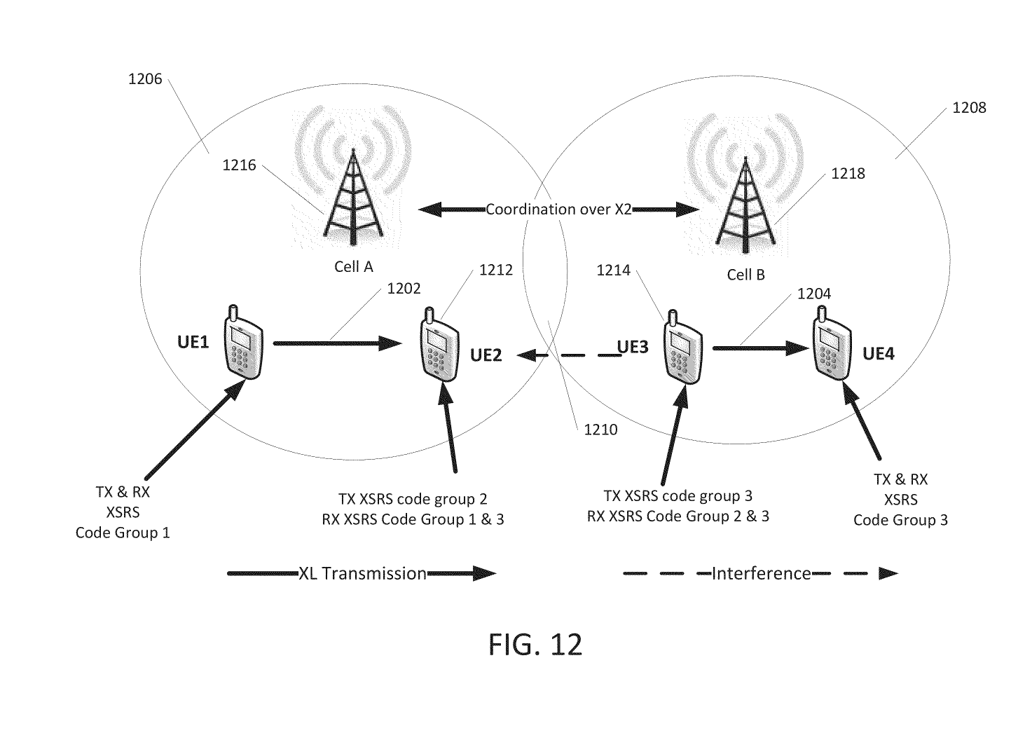

FIG. 12 illustrates an example in which two WTRU-WTRU links 1202, 1204 belonging to separate cells 1206, 1208 may interfere with each other at a cell edge 1210. To detect and avoid HI in such scenarios, some form of base station coordination may be implemented.

One way of coordinating the measurements across a cell edge may involve careful assignment of XSRS code groups. Each WTRU may be assigned its own set of code groups over which the WTRU may make measurements for interference and scheduling purposes. For any given WTRU, the XSRS code group used for transmission may not belong to the XSRS code groups configured for measurement. Each WTRU may be configured to make measurements over a large set of XSRS codes for quicker detection of potential interfering links; however, it may use larger processing requirements.

XSRS codes may be grouped such that the set of codes in each group are orthogonal to each other. Generally, orthogonal codes may provide more accurate measurements. Accordingly, WTRUs that are likely to be close to each other may have a common XSRS code group, such that interference between those WTRUs may be detected and measured. An example of such a code group assignment is shown in FIG. 12. A WTRU 1212 may be configured to make measurements on XSRS code groups 1 and 3, while a WTRU 1214 may be configured to make measurements on XSRS code groups 2 and 3. Such code groups assignment may be derived through standard graph coloring algorithms, provided an initial estimate of the proximity graph is available. The initial proximity graph may be derived through neighbor discovery path loss estimates or though TRL measurements including path loss, direction of travel, and the like. Further location coordinates, including cell tower triangulation or GPS measurements, for example, may be used as initial of the proximity graph.

Interference coordination may be achieved at an individual XSRS code level, instead of the groups, for example. In this mechanism, the eNB may indicate XSRS codes that may be used for measurements for each WTRU.

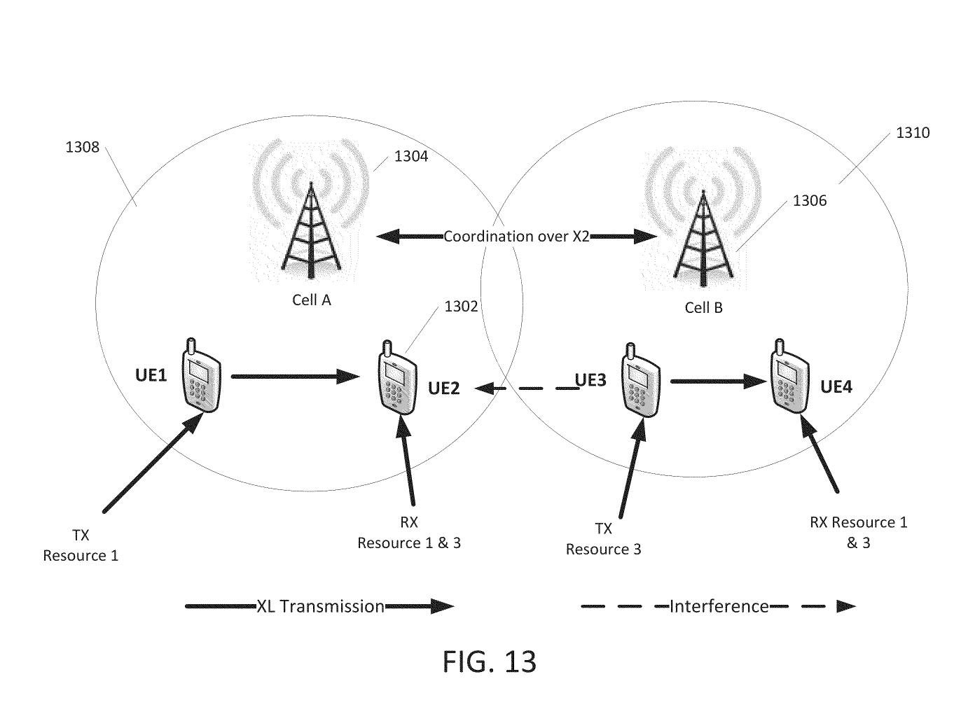

Another way to coordinate interference for scenarios illustrated in FIG. 12 may involve assigning orthogonal frequency domain resources for the D2D links closer to the cell edge 1210. Each Base Station 1216, 1218 may coordinate with its neighboring Base Stations over the resources to be assigned for each D2D link. To facilitate coordination of resource allocation, each of the receiving WTRUs may be configured to make power measurements over a larger set of radio resources. As illustrated in FIG. 13, which illustrates an example of interference coordination of orthogonal resources, a WTRU 1302 may be configured to make power adjustments over both radio resources 1 and 3. These measurements may be sent as feedback to the respective Base Stations 1304, 1306. Since the Base Stations 1304, 1306 may be aware of each other's schedule at some level of granularity, either in time or frequency, it may infer the amount of interference generated from each cell 1308, 1310 to the other. These interference measurements may be used to dynamically share the radio resources between neighboring cells for WTRU to WTRU links.

In addition to the XSRS code, individual WTRU-WTRU links may be separated in the time and/or frequency domain. The measurement opportunities may be coordinated across cells and across individual WTRU-WTRU links, for example. As an example, cell 1308 may have its measurement opportunities configured during odd frames, while cell 1310 may have its measurement opportunities configured during even frames. Each of the WTRUs in RRC Connected Mode may make power measurements during the measurement opportunities and/or report them back to the Base Station. Through Base Station coordination, each of the cells 1308, 1310 may estimate the amount of interference from neighboring cells.

An example of measurement opportunities as disclosed herein may be used for WTRU-WTRU link interference coordination within a cell. According to this example, WTRUs may be partitioned in RRC Connected mode to multiple groups. Each of the groups may have a separate measurement gap during which it may be configured to make interference power measurements, which may be sent to the Base Station 1304, 1306 for scheduling and interference management, for example.

Handoff between TRL and XL may be driven by the link quality measurements and resource availability of the TRL and XL. From a radio resource management perspective, the rate of handoffs may be kept as small as possible. Unlike measurements facilitating scheduling and/or link adaptation purposes, measurements for handoff may be averaged for longer periods of time. Some of the measurements that may be used for handoff may include, but are not limited to: average throughput and/or spectral efficiency of the XL; average SINR of XPCCH or SINR estimate through XSRS (e.g., the eNB may further configure the WTRU to not include SINR measurements while an HI event is detected), and/or average XL path loss measurements obtained through neighbor discovery procedures.

In addition to the measurements configured for the XL, the WTRU may take measurements on the TRL. Examples of such measurements may include, but are not limited to: RSSI on the cell-specific reference signal on the downlink; measurements configured on the uplink through Sounding Reference Signals (SRS) (e.g., these measurements may be configured to make short term and/or long term measurements); and/or link quality measurements, such as SINR and/or CSI on the TRL uplink, that may be readily available at the eNB, as the eNB may be the receiver.

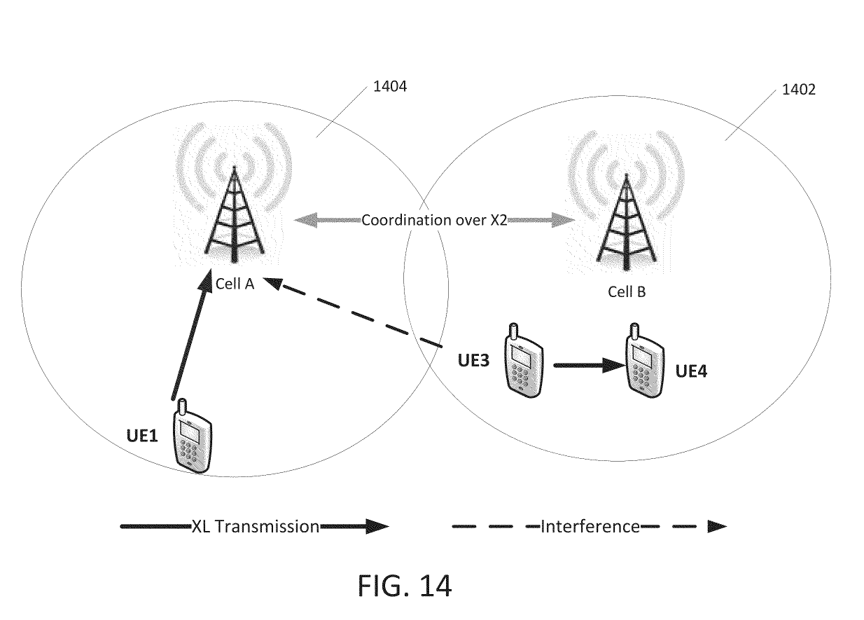

FIG. 14 illustrates an example scenario in which the WTRU-WTRU link from a cell 1402 may interfere with a TRL radio link in a cell 1404. In this example, the TRL Uplink resources may be shared between the TRL and the WTRU-WTRU link. Cell 1404 may detect interference from the D2D link from cell 1402, through XSRS correlation or through receiver power measurements over the shared resources, for example. Measurement gap coordination between cells 1402 and 1404 may yield a more accurate estimate of interference across the cell boundary. Depending on the network policy, cell 1404 may prioritize the TRL and/or indicate to cell 1402 to reschedule the resources used for the WTRU-WTRU link in cell 1402. In the event that cell 1402 may be unable to find resources for the direct WTRU-WTRU link, cell 1402 may terminate the D2D link or force a handoff to TRL.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method comprising:
determining, at a first wireless transmit/receive unit (WTRU), a Sounding Reference Signal (SRS);
communicating the SRS with a second WTRU using a direct link; and
detecting a High Interference (HI) event as a function of the SRS.

2. The method of claim 1, wherein the SRS comprises a cross link Sounding Reference Signal (XSRS) code.

3. The method of claim 2, further comprising sending a High Interference event report comprising at least one of an interfering XSRS code, an index associated with a subframe in which dominant interference is observed, a Received Signal Code Power (RSCP) of an interfering XSRS code, an observed Signal to Interference plus Noise Ratio (SINR), and an observed Received Signal Strength Indicator (RSSI).

4. The method of claim 2, further comprising resolving the High Interference event.

5. The method of claim 4, wherein resolving the High Interference event comprises generating a scheduling grant as a function of the XSRS code.

6. The method of claim 4, wherein resolving the High Interference event comprises revoking a scheduling grant as a function of the XSRS code.

7. The method of claim 4, wherein resolving the High Interference event comprises scheduling a plurality of colliding radio links on orthogonal radio resources.

8. The method of claim 4, wherein resolving the High Interference event comprises assigning respective priorities to a plurality of XSRS codes.

9. The method of claim 2, further comprising performing a measurement on an XSRS code.

10. The method of claim 9, wherein the measurement comprises at least one of a Received Signal Code Power (RSCP) measurement, a path loss measurement, a Signal to Interference plus Noise Ratio (SINR) measurement, a Received Signal Strength Indicator (RSSI) measurement, and a Received Signal Received Quality (RSRQ) measurement.

11. The method of claim 1, further comprising coordinating interference across a plurality of cell sites in a communication network.

12. A wireless transmit/receive unit (WTRU) comprising:
a processor; and
a memory storing processor-readable instructions that, when executed by the processor, cause the WTRU to
determine a Sounding Reference Signal (SRS) comprising a cross link Sounding Reference Signal (XSRS) code;
communicate the SRS with another WTRU using a direct link; and
detect a High Interference (HI) event as a function of the SRS.

13. The WTRU of claim 12, wherein the processor is further configured to send a High Interference event report comprising at least one of an interfering XSRS code, an index associated with a subframe in which dominant interference is observed, a Received Signal Code Power (RSCP) of an interfering XSRS code, an observed Signal to Interference plus Noise Ratio (SINR), and an observed Received Signal Strength Indicator (RSSI).

14. The WTRU of claim 12, wherein the processor is further configured to perform a measurement on an XSRS code, the measurement comprising at least one of a Received Signal Code Power (RSCP) measurement, a path loss measurement, a Signal to Interference plus Noise Ratio (SINR) measurement, a Received Signal Strength Indicator (RSSI) measurement, and a Received Signal Received Quality (RSRQ) measurement.

15. A base station comprising:
a processor; and
a memory storing processor-readable instructions that, when executed by the processor, cause the base station to
receive a High Interference event report associated with a High Interference event, the High Interference event report comprising a plurality of interfering XSRS codes; and
resolving the High Interference event based on the High Interference event report.

16. The base station of claim 15, wherein the base station is configured to resolve the High Interference event at least in part by generating a scheduling grant as a function of the XSRS code.

17. The base station of claim 15, wherein the base station is configured to resolve the High Interference event at least in part by revoking a scheduling grant as a function of the XSRS code.

18. The base station of claim 15, wherein the base station is configured to resolve the High Interference event at least in part by scheduling a plurality of colliding radio links on orthogonal radio resources.

19. The base station of claim 15, wherein the base station is configured to resolve the High Interference event at least in part by assigning respective priorities to a plurality of XSRS codes.

20. The base station of claim 15, wherein the base station is configured to coordinate interference with another base station in a communication network.
